(19) United States
(12) Patent Application Publication
(10) Pub. No.: US 2015/0199750 A1
(43) Pub. Date: Jul. 16, 2015

(54) Quasi-Automated Ordering System and Method

(71) Applicant: Awnex, Inc., Ball Ground, GA (US)

(72) Inventor: Charles Steven McLendon, Waleska, GA (US)

(21) Appl. No.: 14/597,934

(22) Filed: Jan. 15, 2015

Related U.S. Application Data
(60) Provisional application No. 61/927,655, filed on Jan. 15, 2014.

(51) Int. Cl. G06Q 30/06

(52) U.S. Cl. CPC G06Q 30/0635

(57) ABSTRACT

A method, computer program product, and computing system for wirelessly obtaining a unique customer identifier for an entity positioned within a queue of a business. The unique customer identifier is associated with a particular customer. A potential order is identified for the particular customer.

### RELATED APPLICATION

This application claims the benefit of U.S. Provisional Patent Application No. 61/927,655, filed on 15 Jan. 2014 and entitled “Automated Identification and Order Entry”; the entire contents of which are herein incorporated by reference.

### TECHNICAL FIELD

This disclosure relates to order processing systems and, more particularly, to quasi-automated order processing systems.

### BACKGROUND

The ability to quickly and accurately process orders in retail establishments is of paramount importance to the success and profitability of a retail business. Unfortunately, various factors (such as long lines, stress levels, and human error) may compromise the accuracy of such orders and the rate at which these orders may be processed. Accordingly, systems that may aid in the processing of such orders may positively impact the profitability of such businesses.

### SUMMARY OF DISCLOSURE

In one implementation, a computer-implemented method is executed on a computing system. The computer implemented method includes wirelessly obtaining a unique customer identifier for an entity positioned within a queue of a business. The unique customer identifier is associated with a particular customer. A potential order is identified for the particular customer.

One or more of the following features may be included. The potential order may be based, at least in part, upon one or more of: a previous order made by the particular customer; and a preferred order defined by the particular customer. The particular customer may be requested to confirm the potential order. In response to the particular customer confirming the potential order, the potential order may be processed. A predefined method of payment may be identified for the particular customer. Processing the potential order may include processing the potential order using the predefined method of payment. A customer loyalty program may be identified for the particular customer. Processing the potential order may include applying one or more incentives to the customer loyalty program based, at least in part, upon the potential order. Wirelessly obtaining the unique customer identifier for the entity positioned within the queue of the business may include obtaining the unique customer identifier proximate the beginning of the queue. Wirelessly obtaining the unique customer identifier for the entity positioned within the queue of the business may include obtaining the unique customer identifier proximate a point of sale terminal positioned within the queue.

In another implementation, a computer program product resides on a computer readable medium that has a plurality of instructions stored on it. When executed by a processor, the instructions cause the processor to perform operations including wirelessly obtaining a unique customer identifier for an entity positioned within a queue of a business. The unique customer identifier is associated with a particular customer. A potential order is identified for the particular customer.

One or more of the following features may be included. The potential order may be based, at least in part, upon one or more of: a previous order made by the particular customer; and a preferred order defined by the particular customer. The particular customer may be requested to confirm the potential order. In response to the particular customer confirming the potential order, the potential order may be processed. A predefined method of payment may be identified for the particular customer. Processing the potential order may include processing the potential order using the predefined method of payment. A customer loyalty program may be identified for the particular customer. Processing the potential order may include applying one or more incentives to the customer loyalty program based, at least in part, upon the potential order. Wirelessly obtaining the unique customer identifier for the entity positioned within the queue of the business may include obtaining the unique customer identifier proximate the beginning of the queue. Wirelessly obtaining the unique customer identifier for the entity positioned within the queue of the business may include obtaining the unique customer identifier proximate a point of sale terminal positioned within the queue.

In another implementation, a computing system includes at least one processor and at least one memory architecture coupled with the at least one processor, wherein the computing system is configured to perform operations including wirelessly obtaining a unique customer identifier for an entity positioned within a queue of a business. The unique customer identifier is associated with a particular customer. A potential order is identified for the particular customer.

One or more of the following features may be included. The potential order may be based, at least in part, upon one or more of: a previous order made by the particular customer; and a preferred order defined by the particular customer. The particular customer may be requested to confirm the potential order. In response to the particular customer confirming the potential order, the potential order may be processed. A predefined method of payment may be identified for the particular customer. Processing the potential order may include processing the potential order using the predefined method of payment. A customer loyalty program may be identified for the particular customer. Processing the potential order may include applying one or more incentives to the customer loyalty program based, at least in part, upon the potential order. Wirelessly obtaining the unique customer identifier for the entity positioned within the queue of the business may include obtaining the unique customer identifier proximate the beginning of the queue. Wirelessly obtaining the unique customer identifier for the entity positioned within the queue of the business may include obtaining the unique customer identifier proximate a point of sale terminal positioned within the queue.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a quasi-automated ordering process coupled to a distributed computing network;

FIG. 2 is a flow chart of the quasi-automated ordering process of FIG. 1;

FIG. 3A is a diagrammatic view of an RFID tag and an optical tag (affixed to a vehicle) for use with the quasi-automated ordering process of FIG. 1;

FIG. 3B is a diagrammatic view of a key fob for use with the quasi-automated ordering process of FIG. 1;

FIG. 3C is a diagrammatic view of an application for use with the quasi-automated ordering process of FIG. 1; and

FIG. 4 is a diagrammatic view of an alternative queue for use with the quasi-automated ordering process of FIG. 1.

Like reference symbols in the various drawings indicate like elements.

### DETAILED DESCRIPTION OF THE PREFERRED EMBODIMENTS

### System Overview

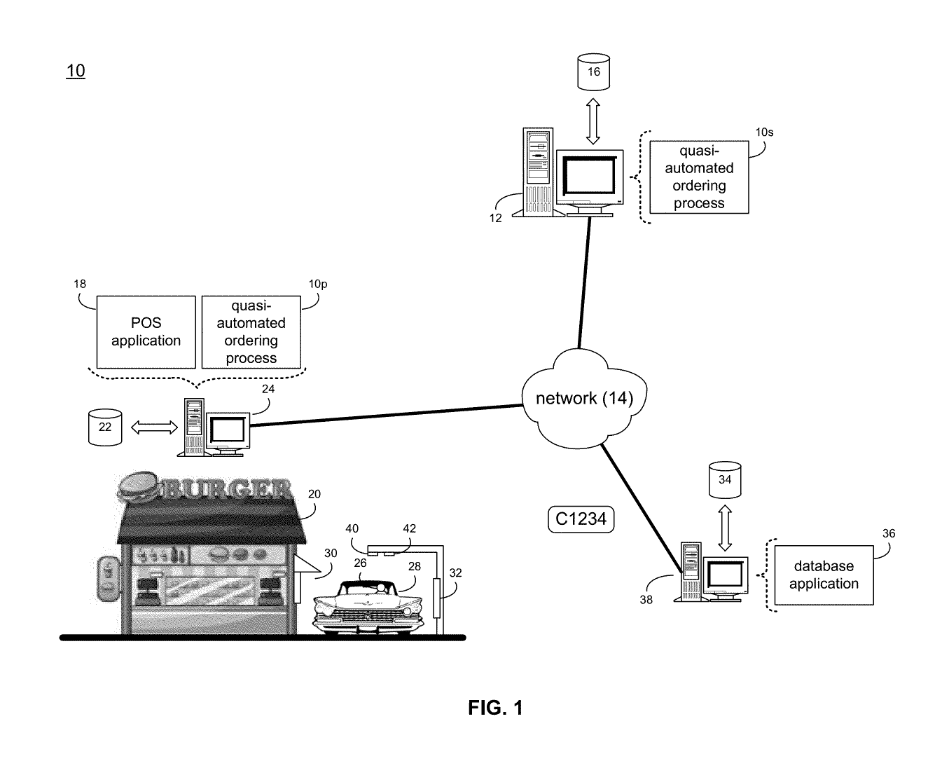

Referring to FIG. 1, there is shown quasi-automated ordering process 10. As will be discussed below in greater detail, quasi-automated ordering process 10 may be configured to assist in the processing of orders at retail businesses.

Quasi-automated ordering process 10 may be implemented on one or more computing systems. For example, quasi-automated ordering process 10 may be implemented as a purely server-side process via server-side quasi-automated ordering process 10s. Alternatively, quasi-automated ordering process 10 may be implemented as a purely POS-side (Point-of-Sale side) process via POS-side quasi-automated ordering process 10p. Alternatively still, quasi-automated ordering process 10 may be implemented as a hybrid server-side/POS-side process via server-side quasi-automated ordering process 10s in combination with POS-side quasi-automated ordering process 10p. Accordingly, quasi-automated ordering process 10 as used in this disclosure may include any combination of server-side quasi-automated ordering process 10s and POS-side quasi-automated ordering process 10p.

Server-side quasi-automated ordering process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of server-side quasi-automated ordering process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices. Any data generated, in whole or in part, by server-side quasi-automated ordering process 10s may be stored on storage device 16 coupled to computing device 12.

POS-side quasi-automated ordering process 10p may be a portion of/a subroutine within/an applet within a point of sale application (e.g., POS application 18) utilized by business 20. Examples of POS application 18 may include but are not limited to: xPient POS Systems; Micros POS; NCR; IBM; ShopKeep; and Panasonic POS System. Examples of business 20 may include but are not limited to businesses that provide food and/or beverages (e.g., coffee houses, donut shops, fast food restaurants, and sandwich shops) to customers.

The instruction sets and subroutines of POS-side quasi-automated ordering process 10p, which may be stored on storage device 22 coupled to computing device 24, may be executed by one or more processors (not shown) and one or more memory architectures (not shown) incorporated into computing device 24. Examples of storage device 22 may include but are not limited to: a hard disk drive; a tape drive; an optical drive; a RAID device; a random access memory (RAM); a read-only memory (ROM); and all forms of flash memory storage devices. Any data generated, in whole or in part, by POS-side quasi-automated ordering process 10p may be stored on storage device 22 coupled to computing device 24.

Examples of computing device 24 may include, but are not limited to a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

Computing device 12 (and server-side quasi-automated ordering process 10s) may communicate with computing device 24 (and POS-side quasi-automated ordering process 10p) via network 14.

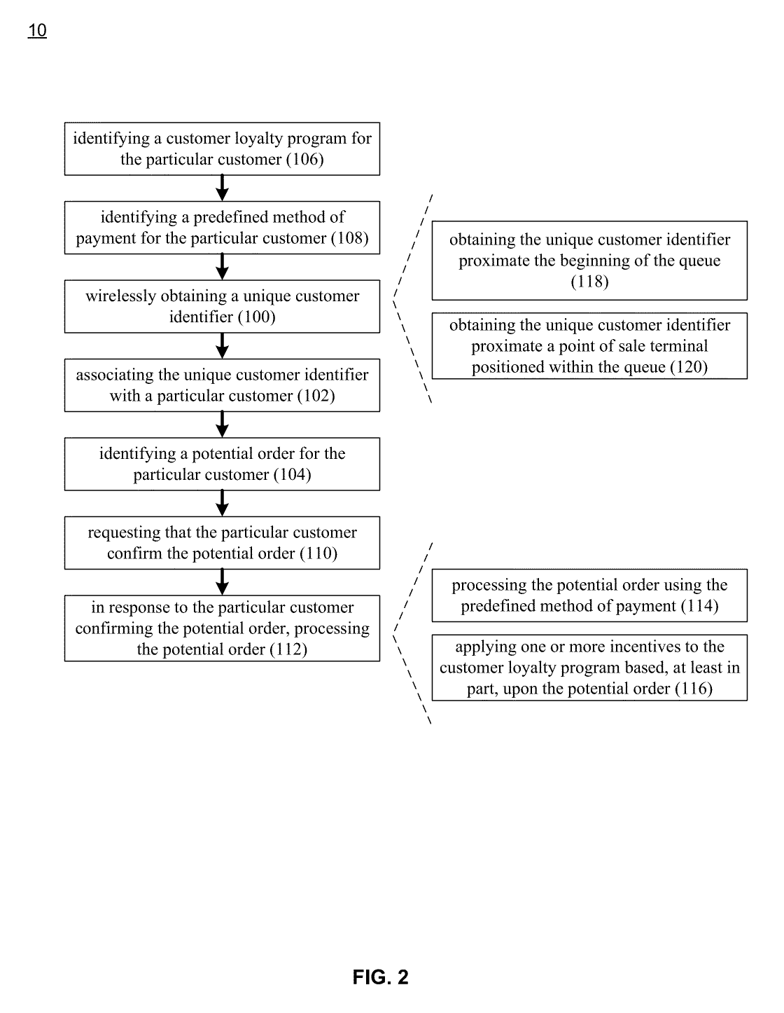

Referring also to FIG. 2 and as will be discussed below in greater detail, quasi-automated ordering process 10 may wirelessly obtain 100 a unique customer identifier for an entity positioned within a queue of business 20, may associate 102 the unique customer identifier with a particular customer, and may identify 104 a potential order for the particular customer. Examples of the queue of business 20 may include but are not limited to a customer line within business 20 and a drive through lane of business 20.

### Quasi-Automated Ordering Process:

For the following example, assume that business 20 is a hamburger restaurant that sells traditional fast food (e.g., hot beverages (coffee/tea), cold beverages (soda/water), fried goods (hamburgers/hot dogs/fries/onion rings), and desserts (ice cream cones/apple pies). Further, assume that business 20 includes a drive through lane that allows customers (e.g., customer 26) to place orders from within their vehicle (e.g., vehicle 28) and pickup those orders at order window 30. As is known, such drive through lanes may be more sophisticated and may include remote menu/communication system 32 into which customer 26 within vehicle 28 may place their order. Alternatively, such drive through lanes may be more traditional and may not include remote menu/communication system 32 and may require customer 26 within vehicle 28 to place their order at order window 30.

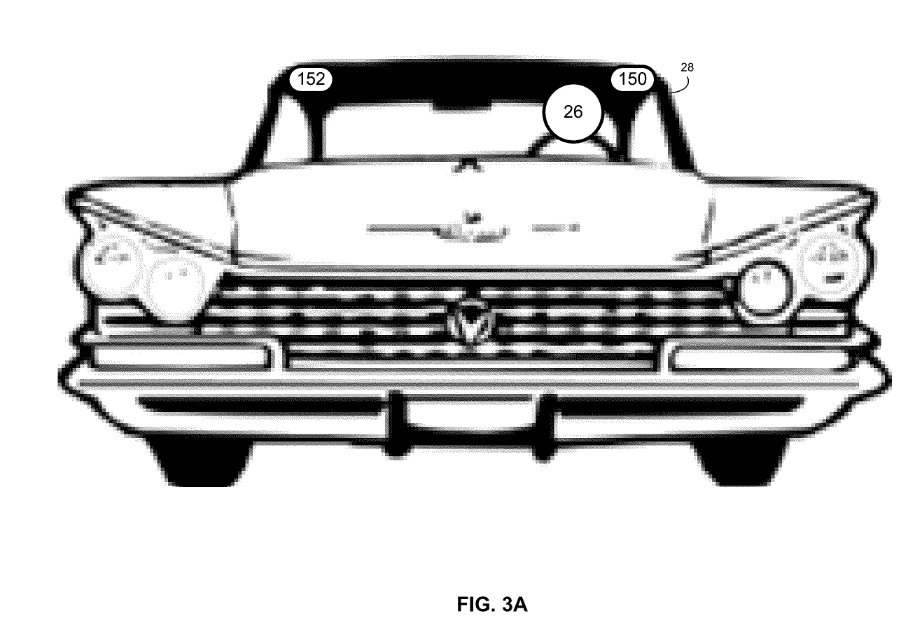

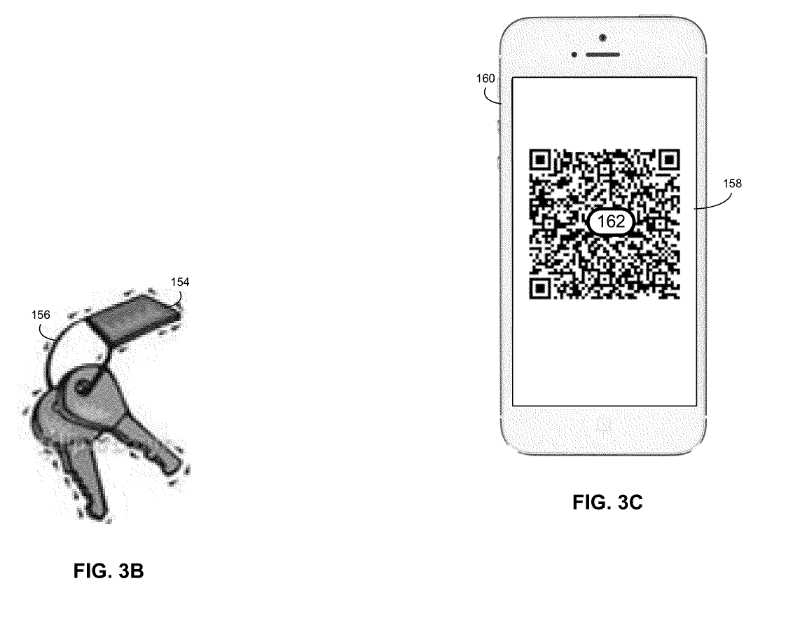

Assume for illustrative purposes that when customer 26 initially visits business 20 and makes a purchase, customer 26 is given an object that is configured to uniquely identify customer 26. Specifically and referring also to FIGS. 3A-3C, this object may include a unique customer identifier associated exclusively with (in this example) customer 26.

Examples of such an object may include, but is not limited to, an RFID tag (e.g., RFID tag 150) that may be configured to be affixed to e.g., vehicle 28. As is known in the art, RFID tag 150 may be a device that is configured to be wirelessly energized by a remote power source and respond to such energizing by providing a wireless data signal to a remote receiver. In this embodiment, this wireless data signal may include the above-referenced unique customer identifier associated exclusively with (in this example) customer 26. Accordingly and through the use of RFID tag 150, customer 26 may be identified.

Another example of such an object may include, but is not limited to, an optical tag (e.g., optical tag 152) that may be configured to be affixed to e.g., vehicle 26. As is known in the art, optical tag 152 may be a sticker that includes unique optical indicia (e.g., a bar code) and is configured to be optically scanned by a remote optical scanner. In this embodiment, this unique optical indicia may include/be associated with the above-referenced unique customer identifier associated exclusively with (in this example) customer 26. Accordingly and through the use of optical tag 152, customer 26 may be identified.

Still, another example of such an object may include a key fob (e.g., key fob 154) that is configured to e.g., attach to a key ring (e.g., key ring 156) and be in the possession of customer 26. Examples of key fob 154 may include but are not limited to an RFID key fob and an optical key fob. An RFID key fob may be configured to be wirelessly energized by a remote power source and respond to such energizing by providing a wireless data signal (including the above-referenced unique customer identifier) to a remote receiver. An optical key fob may include unique optical indicia (e.g., a bar code) and may be configured to be optically scanned by a remote optical scanner, wherein this unique optical indicia may include/be associated with the above-referenced unique customer identifier.

Further still, another example of such an object may include an application (e.g., application 158) that is configured to be installed onto and run on handheld device 160 (e.g., an iOS or Android device) in the possession of customer 26. Examples of application 158 may include but are not limited to an application that is configured to uniquely identify customer 26 by generating unique optical indicia 162 that may be scanned by a remote optical scanner, wherein unique optical indicia 162 may include/be associated with the above-referenced unique customer identifier. Alternatively, application 58 may be configured to provide a wireless data signal (including the above-referenced unique customer identifier) to a remote receiver via e.g., a wifi network or Bluetooth.

Assuming that customer 26 wants to utilize quasi-automated ordering process 10, customer 26 may e.g., affix RFID tag 150 to vehicle 28, affix optical tag 152 to vehicle 28, add key fob 154 to key ring 156, and/or download and install application 158 onto handheld device 160. Further, assume that customer 26 completed a registration process at e.g., a website associated with business 20. Accordingly and through the use of such a registration process, customer 26 may be able to provide identifying information (e.g., name and address) and contact information (e.g., telephone number, email address) for association with the above-described unique customer identifier. Alternatively, the above-described registration process may be completed while customer 26 is at business 20. For example, an attendant at business 20 may ask customer 26 for the required information.

Such identifying information and contact information may be encoded within RFID tag 150, optical tag 152, key fob 154, and/or application 158. Additionally/alternatively, such identifying information and contact information may be stored within database 34 that is accessible via database application 36 executed on computing device 38.

Examples of computing device 38 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

Database 34 and/or database application 36 may be stand-alone systems or may be included within/a portion of POS application 18. In such a configuration, computing device 24 and computing device 38 may be a single computing device.

If business 20 includes multiple locations, database 34, database application 36 and/or computing device 38 may be located at a site accessible (e.g., via network 14) by all locations of business 20. Alternatively, if business 20 includes a single location, database 34, database application 36 and/or computing device 38 may be located within the confines of business 20.

When registering e.g., RFID tag 150, optical tag 152, key fob 154, and/or application 158, quasi-automated ordering process 10 may allow customer 26 to identify 106 a customer loyalty program for customer 26 concerning business 20. For example, if customer 26 is already a member of such a customer loyalty program, quasi-automated ordering process 10 may allow customer 26 to identify 106 a preexisting customer loyalty program for the above-described unique customer identifier. If customer 26 is not a member of such a customer loyalty program, quasi-automated ordering process 10 may allow customer 26 to first enroll in such a customer loyalty program. Such customer loyalty program information may be stored within database 34 that is accessible via database application 36 executed on computing device 38 and/or encoded within RFID tag 150, optical tag 152, key fob 154, and/or application 158. As discussed above, the above-described registration process may be completed by customer 26 at e.g., a website associated with business 20 and/or via an attendant while customer 26 is at business 20.

Further and while registering e.g., RFID tag 150, optical tag 152, key fob 154, and/or application 158, quasi-automated ordering process 10 may allow customer 26 identify 108 a predefined method of payment for customer 26. Further example, quasi-automated ordering process 10 may be configured to allow customer 26 to store e.g., predefined payment information (e.g., credit card information) so that future purchases made by customer 26 may be settled via this predefined payment information (e.g., in a pre-pay or post-pay fashion). Such predefined payment information may be stored within database 34 that is accessible via database application 36 executed on computing device 38 and/or encoded within RFID tag 150, optical tag 152, key fob 154, and/or application 158. As discussed above, the above-described registration process may be completed by customer 26 at e.g., a website associated with business 20 and/or via an attendant while customer 26 is at business 20.

As discussed above, when customer 26 initially visits business 20 and makes a purchase, customer 26 may be given an object (e.g., RFID tag 150, optical tag 152, key fob 154, and/or application 158) that may be configured to uniquely identify customer 26 (via a unique customer identifier associated exclusively with customer 26). Additionally, the purchase made by customer 26 may be associated with this unique customer identifier. Assume for illustrative purposes that the unique customer identifier C1234 is associated with customer 26 (who is named Kevin Brown). Further, assume for this example that during the initial visit, customer 26 purchased a large regular coffee and a sesame bagel with cream cheese.

Continuing with the above-stated example, assume that customer 26 affixed RFID tag 150 to vehicle 28 and subsequently returns to the drive through lane of business 20. Upon arriving in the drive through lane of business 20, RFID tag 150 (as shown in FIG. 2A) may be wirelessly energized by a remote power source (e.g., remote power source 40). In response to being energized, RFID tag 150 may provide a wireless data signal to remote receiver 42, wherein this wireless data signal may include the unique customer identifier (C1234) associated exclusively with (in this example) customer 26.

Specifically, quasi-automated ordering process 10 may wirelessly obtain 100 the unique customer identifier (C1234) for an entity (in this example, vehicle 28) positioned within a queue (in this example, a drive through lane) of business 20. Quasi-automated ordering process 10 may then associate 102 the unique customer identifier (C1234) with a particular customer (e.g., customer 26). For example, upon obtaining 100 the unique customer identifier (C1234), quasi-automated ordering process 10 may provide the unique customer identifier (C 1234) to database 34 and/or database application 36. Database 34 and/or database application 36 may execute a query based upon the unique customer identifier (C1234) and identify customer 26 (the customer associated with the unique customer identifier) as Kevin Brown. Accordingly, quasi-automated ordering process 10 may then associate 102 the unique customer identifier (C1234) obtained 100 with a particular customer (e.g., customer 26, namely Kevin Brown). Quasi-automated ordering process 10 may provide this information (e.g., the name of customer 26) to POS application 18, thus allowing the person communicating with customer 26 to greet them by name (e.g., “Welcome back Kevin, how may I help you today?”).

Alternatively, quasi-automated ordering process 10 may be configured to operate without needing to access external database 34 and/or database application 36. For example, the above-described customer information may be encoded within RFID tag 150, optical tag 152, key fob 154, and/or application 158. Accordingly and for this example, the name of the customer (“Kevin Brown”) may be encoded within RFID tag 150, optical tag 152, key fob 154, and/or application 158, wherein such information may be wirelessly provided to quasi-automated ordering process 10 so that quasi-automated ordering process 10 may associate 102 the unique customer identifier (C1234) obtained 100 with a particular customer (e.g., customer 26, namely Kevin Brown), thus allowing the person communicating with customer 26 to greet them by name (e.g., “Welcome back Kevin, how may I help you today?”).

Quasi-automated ordering process 10 may further identify 104 a potential order for customer 26 (e.g., from database 34 and/or database application 36). Quasi-automated ordering process 10 may obtain this information from e.g., database 34 and/or database application 36. As discussed above, the initial purchase made by customer 26 may be associated with this unique customer identifier (C1234), wherein customer 26 purchased a large regular coffee and a sesame bagel with cream cheese during their initial visit to business 20. Quasi-automated ordering process 10 may provide this information (e.g., the last order made by customer 26) to POS application 18, thus allowing the person communicating with customer 26 to make a suggestion for purchase (e.g., “Would you like a large regular coffee and a sesame bagel with cream cheese this morning?”).

Alternatively, information concerning this potential order for customer 26 may be encoded within RFID tag 150, optical tag 152, key fob 154, and/or application 158. As discussed above, the initial purchase made by customer 26 during their initial visit to business 20 included a large regular coffee and a sesame bagel with cream cheese. At the time of purchase, the attendant assisting customer 26 may have encoded information concerning this order (e.g., a large regular coffee and a sesame bagel with cream cheese) within RFID tag 150, optical tag 152, key fob 154, and/or application 158 provided to customer 26. For example and in the situation where RFID tag 150 is utilized, prior to providing RFID tag 150 to customer 26, the attendant may encode this information into RFID tag 150. Accordingly, when quasi-automated ordering process 10 identifies 104 a potential order for customer 26, the potential order information may be obtained from (in this example) RFID tag 150 and provided to POS application 18, thus allowing the person communicating with customer 26 to make a suggestion for purchase (e.g., “Would you like a large regular coffee and a sesame bagel with cream cheese this morning?”).

Accordingly, this potential order may be based, at least in part, upon a previous order made by the particular customer. This may be dynamically adjusted, wherein quasi-automated ordering process 10 may redefine the potential order as the last order that (in this example) customer 26 made. For example, database 34 and/or database application 36 may be updated each time that customer 26 makes a new purchase. Alternative and in this example, RFID tag 150 may be re-encoded (e.g., by a wireless programming device (not shown) positioned proximate order window 30) each time that customer 26 makes a new purchase. Alternatively, quasi-automated ordering process 10 may be configured to allow (in this example) customer 26 to define a preferred order via the above-described registration process).

Quasi-automated ordering process 10 may request 110 that customer 26 confirm this potential order (e.g., a large regular coffee and a sesame bagel with cream cheese). For example, quasi-automated ordering process 10 may request 110 that the person communicating with customer 26 confirm that customer 26 wants the potential order. Alternatively and where the ordering process is more automated, quasi-automated ordering process 10 may directly request 110 (via e.g., an onscreen prompt) that customer 26 confirm the potential order.

In response to customer 26 confirming the potential order, quasi-automated ordering process 10 may process 112 the potential order (e.g., a large regular coffee and a sesame bagel with cream cheese).

Continuing with the above-described example, assume that customer 26 is associated with customer loyalty program (Account# L1234), has predefined payment information (e.g., credit card information), and has a predefined method of payment (e.g., charging against their prepaid balance), which is currently at $15.00. Quasi-automated ordering process 10 may obtain this information from e.g., database 34 and/or database application 36. Quasi-automated ordering process 10 may provide this information (e.g., the customer loyalty program account number, predefined payment information, and predefined method of payment) to POS application 18.

Alternatively, information concerning the customer loyalty program of customer 26, the predefined payment information (e.g., credit card information) of customer 26, and the predefined method of payment (e.g., charging against their prepaid balance) for customer 26 may be stored within RFID tag 150, optical tag 152, key fob 154, and/or application 158 (during e.g., the above-described registration process). Accordingly, quasi-automated ordering process 10 may obtain this information from (in this example) RFID tag 150 and provide the same to POS application 18.

Assume for this example that a large regular coffee and a sesame bagel with cream cheese at business 20 costs $7.00. Accordingly and when processing 112 the potential order (e.g., a large regular coffee and a sesame bagel with cream cheese), quasi-automated ordering process 10 may process 114 the potential order using the predefined method of payment (e.g., charging against their prepaid balance). Accordingly, the person communicating with customer 26 may inquire concerning payment options (e.g., “Would you like to charge this purchase against your prepaid balance of $15.00?). Further, if the prepaid balance of customer 26 has fallen below a predefined minimum (e.g., $20.00), the person communicating with customer 26 may inquire as to whether customer 26 would like to replenish their prepaid balance using the predefined payment information (e.g., “Would you like to add an additional $50.00 to your prepaid balance?).

Further and when processing 112 the potential order (e.g., a large regular coffee and a sesame bagel with cream cheese), quasi-automated ordering process 10 may apply 116 one or more incentives to the above-described customer loyalty program based, at least in part, upon the potential order. As discussed above, customer 26 is associated with customer loyalty program (Account# L1234). Accordingly, quasi-automated ordering process 10 may apply to customer loyalty program account # L1234 any incentives (e.g., points, cash back, free regular coffees) that are associated with customer 26 purchasing the potential order (e.g., a large regular coffee and a sesame bagel with cream cheese).

The location within the queue where quasi-automated ordering process 10 wirelessly obtains 100 the unique customer identifier (C1234) for the entity (e.g., vehicle 28 within which customer 26 is riding) positioned within the queue (e.g., the drive through lane) of business 20 may vary depending upon e.g., the type of food/beverages being offered by business 20. For example, for food/beverages that take a longer period of time to prepare (e.g., hamburgers/pizza), quasi-automated ordering process 10 may obtain 118 the unique customer identifier (C1234) proximate the beginning of the queue (thus giving employees of business 20 a sufficient quantity of time to prepare the hamburgers/pizza). Accordingly, remote power source 40 and remote receiver 42 (for this example) may be positioned proximate the point where (in this example) vehicle 28 first enters the drive through lane of business 20. Conversely, for food/beverages that take a shorter period of time to prepare (e.g., hot coffee), quasi-automated ordering process 10 may obtain 120 the unique customer identifier (C1234) proximate a point of sale terminal positioned within the queue (thus preventing the hot coffee from sitting around long enough to get cold). Accordingly, remote power source 40 and remote receiver 42 (for this example) may be positioned proximate order window 30 of business 20.

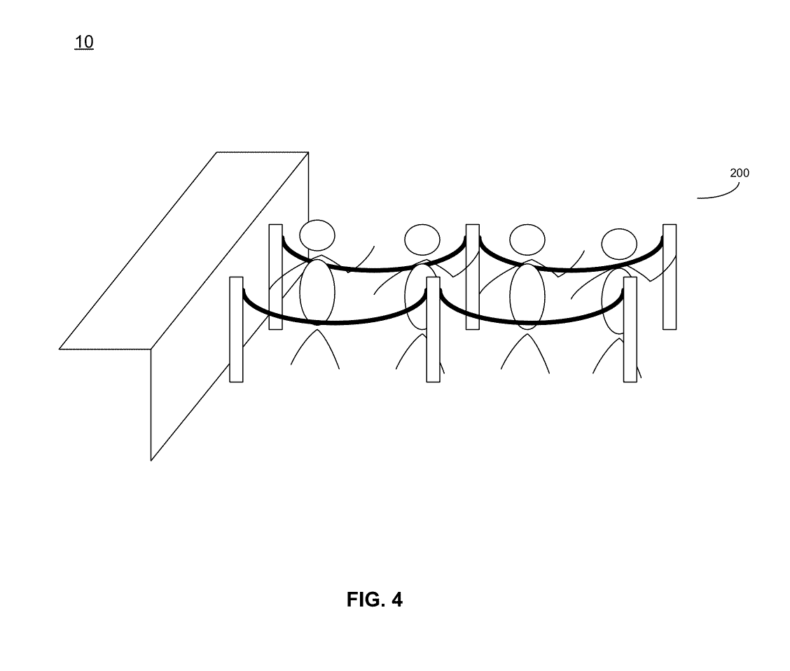

As discussed above, examples of the queue of business 20 may include but are not limited to a customer line within business 20 and a drive through lane of business 20. Accordingly, while the above-described example discussed vehicle 28 entering the drive through lane of business 20, this is for illustrative purposes only and is not intended to be a limitation of this disclosure. For example and as shown in FIG. 4, the queue may be customer line 200 within business 20 (e.g., a line of people waiting to order a meal). In this example, the above-described remote power source/receiver (for RFID tags) or an optical scanner (for optical tags) may be positioned proximate the beginning or the end of customer line 200 (for the reasons discussed above).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing system, the computer implemented method comprising:
wirelessly obtaining a unique customer identifier for an entity positioned within a queue of a business;
associating the unique customer identifier with a particular customer; and
identifying a potential order for the particular customer.

2. The computer-implemented method of claim 1 wherein the potential order is based, at least in part, upon one or more of:
a previous order made by the particular customer; and
a preferred order defined by the particular customer.

3. The computer-implemented method of claim 1 further comprising:
requesting that the particular customer confirm the potential order, and
in response to the particular customer confirming the potential order, processing the potential order.

4. The computer-implemented method of claim 3 further comprising:
identifying a predefined method of payment for the particular customer;
wherein processing the potential order includes:
processing the potential order using the predefined method of payment.

5. The computer-implemented method of claim 3 further comprising:
identifying a customer loyalty program for the particular customer;
wherein processing the potential order includes:
applying one or more incentives to the customer loyalty program based, at least in part, upon the potential order.

6. The computer-implemented method of claim 1 wherein wirelessly obtaining the unique customer identifier for the entity positioned within the queue of the business includes obtaining the unique customer identifier proximate the beginning of the queue.

7. The computer-implemented method of claim 1 wherein wirelessly obtaining the unique customer identifier for the entity positioned within the queue of the business includes
obtaining the unique customer identifier proximate a point of sale terminal positioned within the queue.

8. A computer program product residing on a computer readable medium having a plurality of instructions stored thereon which, when executed by a processor, cause the processor to perform operations comprising:
wirelessly obtaining a unique customer identifier for an entity positioned within a queue of a business;
associating the unique customer identifier with a particular customer; and
identifying a potential order for the particular customer.

9. The computer program product of claim 8 wherein the potential order is based, at least in part, upon one or more of:
a previous order made by the particular customer; and
a preferred order defined by the particular customer.

10. The computer program product of claim 8 further comprising:
requesting that the particular customer confirm the potential order, and
in response to the particular customer confirming the potential order, processing the potential order.

11. The computer program product of claim 10 further comprising:
identifying a predefined method of payment for the particular customer;
wherein processing the potential order includes:
processing the potential order using the predefined method of payment.

12. The computer program product of claim 10 further comprising:
identifying a customer loyalty program for the particular customer;
wherein processing the potential order includes:
applying one or more incentives to the customer loyalty program based, at least in part, upon the potential order.

13. The computer program product of claim 8 wherein wirelessly obtaining the unique customer identifier for the entity positioned within the queue of the business includes obtaining the unique customer identifier proximate the beginning of the queue.

14. The computer program product of claim 8 wherein wirelessly obtaining the unique customer identifier for the entity positioned within the queue of the business includes
obtaining the unique customer identifier proximate a point of sale terminal positioned within the queue.

15. A computing system including a processor and memory configured to perform operations comprising:
wirelessly obtaining a unique customer identifier for an entity positioned within a queue of a business;
associating the unique customer identifier with a particular customer; and
identifying a potential order for the particular customer.

16. The computing system of claim 15 wherein the potential order is based, at least in part, upon one or more of:
a previous order made by the particular customer.
a preferred order defined by the particular customer.

17. The computing system of claim 15 further comprising:
requesting that the particular customer confirm the potential order, and
in response to the particular customer confirming the potential order, processing the potential order.

18. The computing system of claim 17 further comprising:
identifying a predefined method of payment for the particular customer;
wherein processing the potential order includes:
processing the potential order using the predefined method of payment.

19. The computing system of claim 17 further comprising:
identifying a customer loyalty program for the particular customer;
wherein processing the potential order includes:
applying one or more incentives to the customer loyalty program based, at least in part, upon the potential order.

20. The computing system of claim 15 wherein wirelessly obtaining the unique customer identifier for the entity positioned within the queue of the business includes obtaining the unique customer identifier proximate the beginning of the queue.

21. The computing system of claim 15 wherein wirelessly obtaining the unique customer identifier for the entity positioned within the queue of the business includes
obtaining the unique customer identifier proximate a point of sale terminal positioned within the queue.
